(19) United States
(12) Patent Application Publication
(10) Pub. No.: US 2016/0060896 A1
(43) Pub. Date: Mar. 3, 2016

(54) Tent Leg Wheel/Foot Assembly

(71) Applicant: Jeffrey Robert Toohey, Newcastle, CA (US)

(72) Inventor: Jeffrey Robert Toohey, Newcastle, CA (US)

(21) Appl. No.: 14/471,876

(22) Filed: Aug. 28, 2014

(51) Int. Cl. E04H 15/32; B60B 33/00

(52) U.S. Cl. CPC E04H 15/32; B60B 33/0002

(57) ABSTRACT

Wheels, or castors, are attached to the legs of what are commonly called collapsible shelters. The wheels, or castors, can be added to some or all of the legs, of which there are normally four. The wheels, or castors, can be of any type and attached in any fashion, i.e., bolted, clamped, welded, screwed, snapped in, grooved, pressed, glued, spring activated, telescopic, drop-down, rotational, slide, etc.

### CROSS-REFERENCE TO RELATED APPLICATIONS

1. Provisional patent application No. 61/959,583 dated Aug. 28, 2013, confirmation number 5676

2. Provisional patent application No. 61/960,327 dated Sep. 16, 2013, confirmation number 9853

### STATEMENT REGARDING FEDERALLY SPONSORED RESEARCH OR DEVELOPMENT

not applicable

### REFERENCE TO SEQUENCE LISTING, A TABLE, OR A COMPUTER PROGRAM LISTING COMPACT DISC APPENDIX

not applicable

### BACKGROUND OF THE INVENTION

Collapsible shelters without bases (as opposed to those with bases, see U.S. Pat. No. 7,604,212) and elevated canopies have been in use since at least 1986 (see U.S. Pat. No. 4,607,656). These units almost always have four legs. Usually a metal foot can be spiked to the ground in order to stop the unit from blowing away in gusty weather.

Problems with prior art—Unfortunately, these feet inhibit the ability for any one single person to set them up, move them, or tear them down. Most of the shelters listed above have some sort of flattened skid plate type of foot attached to an angled telescopic leg that tends to dig into the ground when erecting or tearing down the unit. Not only is this frustrating and difficult but it puts undo stress upon the fragile collapsible frames, decreasing the life of the unit, sometimes significantly. Once the fragile metal is bent the unit will neither close nor open properly again, precluding it from fitting into its tightly fitted travel case. While certainly not impossible, it is difficult for one person to set up the unit by themselves. During setup a single individual needs to expand, or pull apart the collapsible unit one leg at a time, constantly circling the structure and moving from one leg to the other, pulling and pushing simultaneously, gaining and losing ground until the unit is fully expanded and all pieces are locked in place. Depending on ground and weather conditions this can take as long as 5-10 minutes. The teardown can be just as problematic. Very often help is recruited on site for setup, movement, and teardown. In fact, several of these patents (U.S. Pat. Nos. 7,640,943 and 5,511,572) show two people involved in the setup in the actual drawings submitted with the patent; optimally 4 people are needed.

Additionally, because of the many scissor joints endemic to these units, the chances of becoming pinched are increased as the unit sticks, resists and releases violently.

Applicable US patent classification numbers include 135/124, 135/131, 135/145, 135/128, 135/126, 135/120.3, 52/109

### BRIEF SUMMARY OF THE INVENTION

The invention calls for a castor, or wheel assembly to be added to each of the leg assemblies, replacing the high friction skid plates with a low friction rolling device. In most cases there will be four.

The invention is both an improvement on the original design and a standalone upgrade to existing units. It can be used for new units or to retrofit models already placed in service.

Its purpose is to facilitate the setup/teardown process allowing a single person to manage these task with much greater ease. Instead of the constant resistance provided by the standard feet that come with these units the castors/wheels allow one person to easily erect, teardown, or move the unit by themselves.

The invention is to be used with baseless, shelter units like those found in U.S. Pat. No. 7,640,943 wherein people sit and move about under the canopy and often relocate the unit to maximize shade or block wind and is not related to the functionality of wheels found on patents like U.S. Pat. No. 7,604,212 that include a collapsible/telescoping base unit that restricts traffic and precludes safe mobility underneath. Those types of collapsible structures are fundamentally different from the shelter structures in both use and setup.

There are a variety of ways in which a castor/wheel can be applied to the legs of these units depending on how the original leg was/is manufactured. They include but are not limited to welds, bolts, screws, clamps, glues, pressed or built in as one unit. The wheels may be removable or permanent. There are also a large variety of wheel types that can be used including but not limited to rubber, plastic, vinyl, poly vinyls, composites, etc. This patent is meant to include any type of wheel using any means of attachment, whether temporary or permanent.

### BRIEF DESCRIPTION OF THE SEVERAL VIEWS OF THE DRAWING

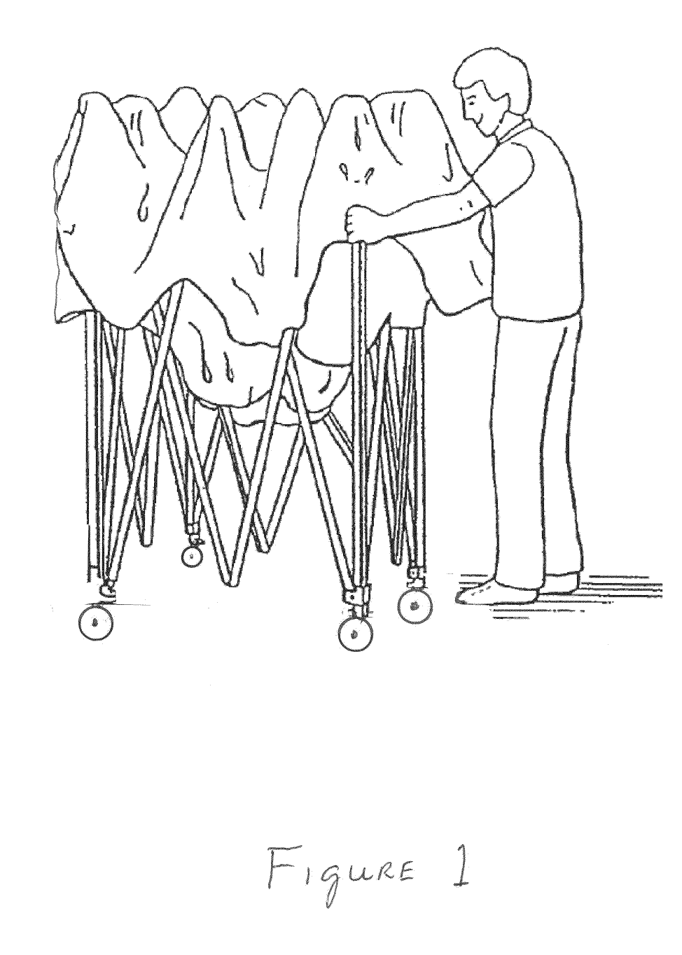

1) FIG. 1—one person opening or closing the collapsible shelter by themselves

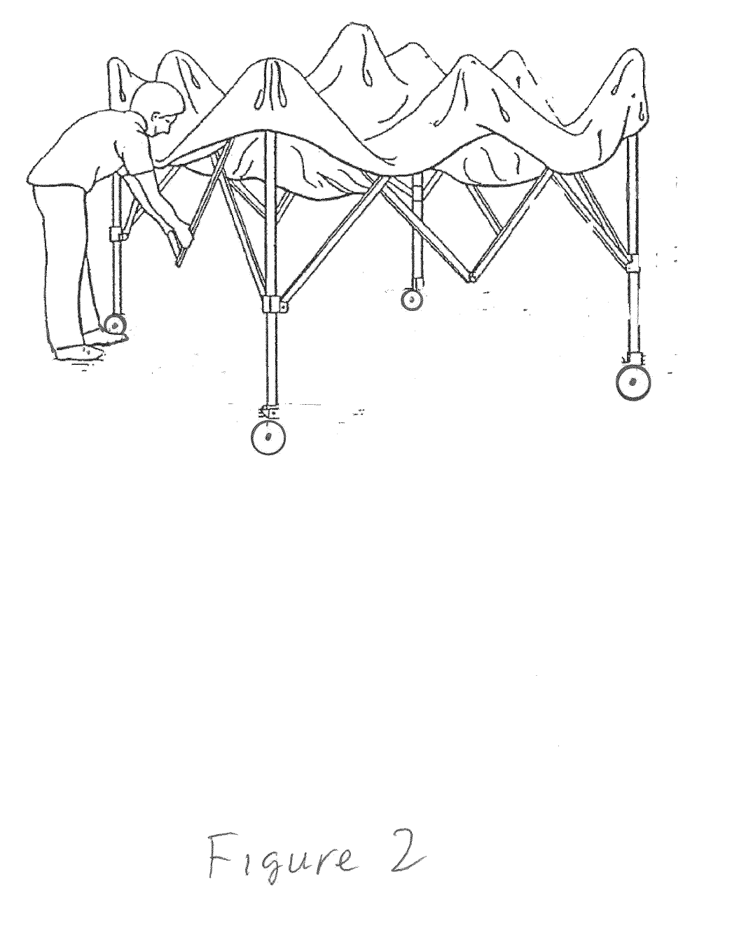

2) FIG. 2—again, one person opening or closing the collapsible shelter by themselves

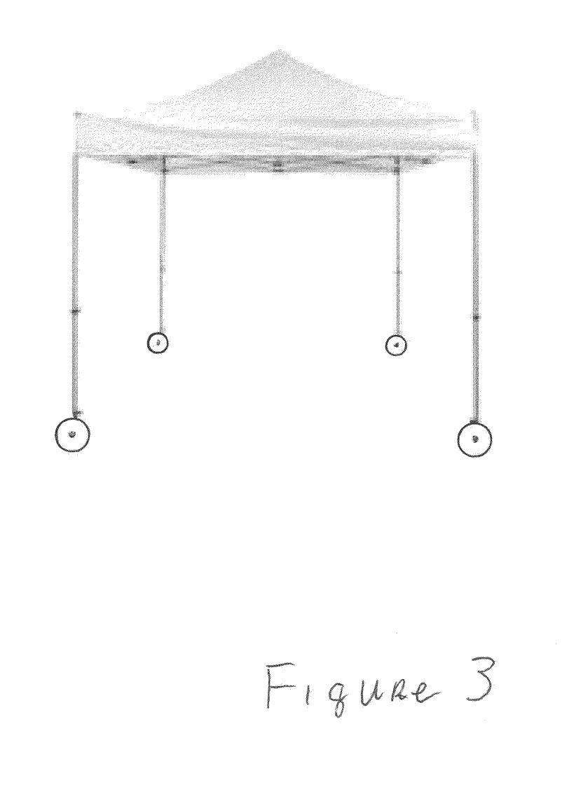

3) FIG. 3—collapsible shelter fully set up

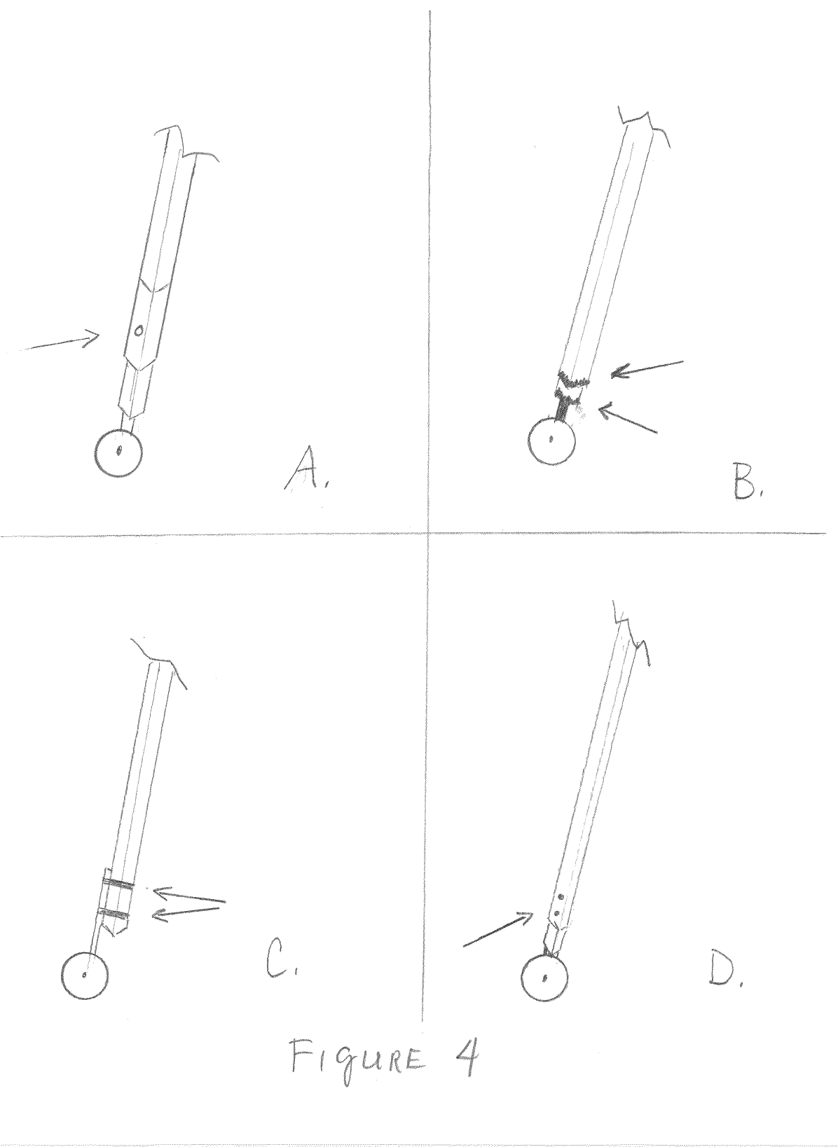

4) FIG. 4—A) snapped B) welded C) clamped D) screwed or bolted

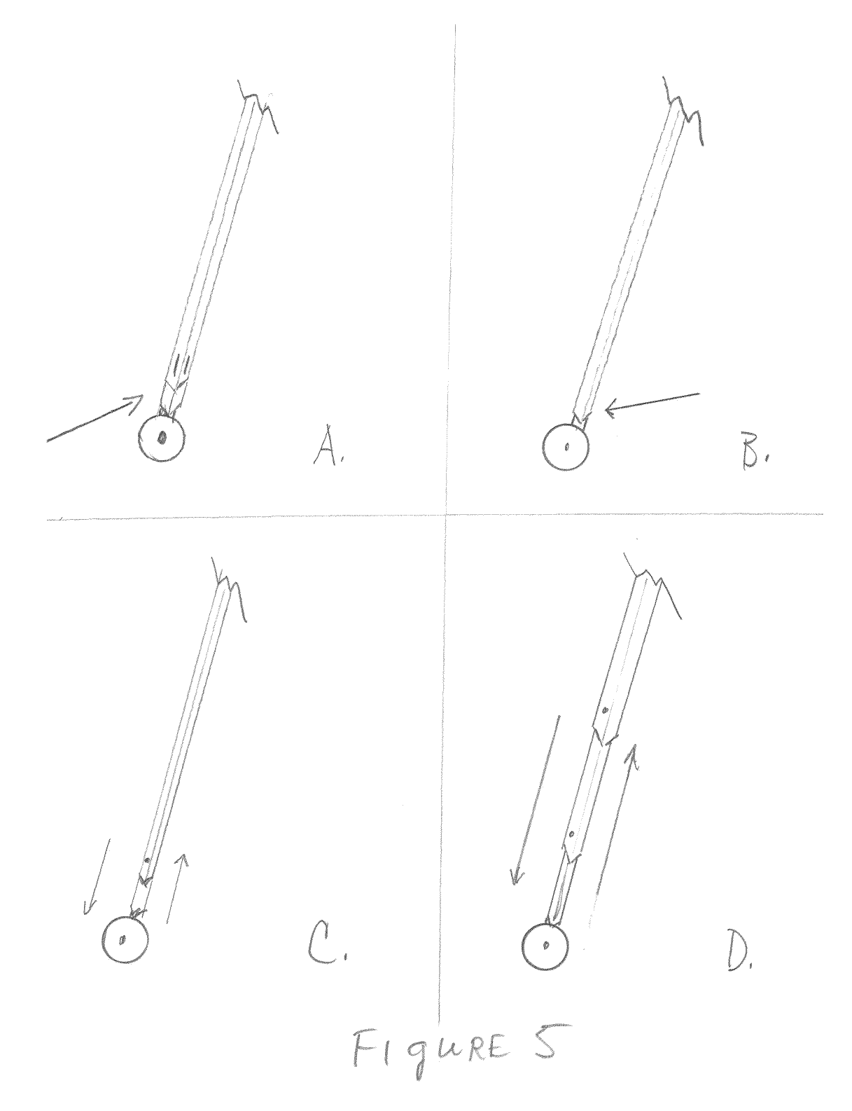

5) FIG. 5—A) pressed or grooved B) glued C) drop down D) Telescopic

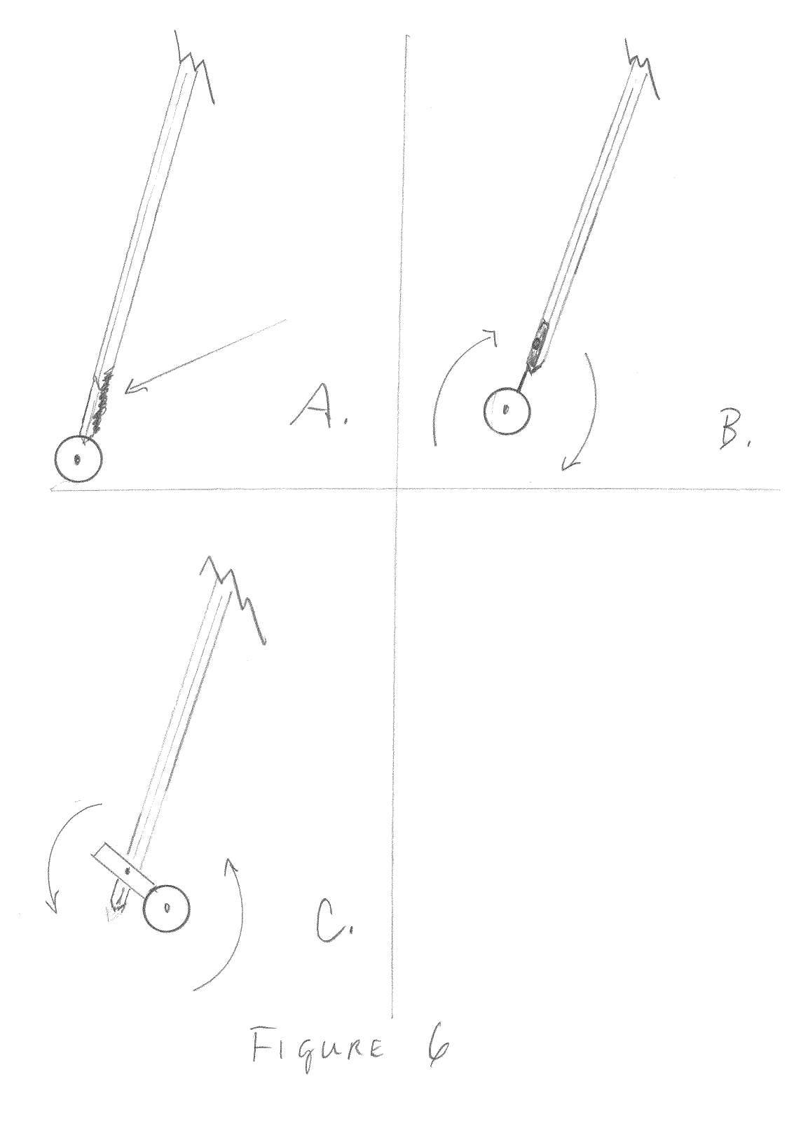

6) FIG. 6—A) spring activated B) rotational C) rotational (alt)

### DETAILED DESCRIPTION OF THE INVENTION

There are a variety of ways in which a castor/wheel can be applied to the legs of these units depending on how the original leg was/is manufactured. They include but are not limited to welds, bolts, screws, clamps, glues, pressed or built in as one unit. The wheels may be removable or permanent. There are also a large variety of wheel types that can be used including but not limited to rubber, plastic, vinyl, poly vinyls, composites, etc. This patent is meant to include any type of wheel using any means of attachment, whether temporary or permanent.

FIGS. 1-3 show one person setting up and tearing down the collapsible shelter. FIGS. 4-6 show a variety of ways, but not all, in which the wheels can be attached to the legs.

1. A faster method that allows one person, by them self, to easily set up, teardown, or move a collapsible shelter where:
a. wheels are attached (in any manner) to the feet, or bottom portion of the legs of a new or existing collapsible shelter that allows those legs to slide freely and without the friction and the torque that is normally associated with the current design found in collapsible structures as they are set up, tore down, or moved.

2. By adding wheels as in claim 1, a safer method of setting up, tearing down, or moving a collapsible shelter that greatly reduces the propensity of the scissor mechanism portion of the structure to pinch the person performing the above action/s by reducing friction and stress on the structure.

3. By adding wheels as in claim 1, a method of adding useful life to a collapsible shelter by reducing undo tension and torque that tends to bend or damage the fragile scissors mechanisms and thus compromising or eliminating the structures ability to open and close properly.
